(19) United States
(12) Patent Application Publication
(10) Pub. No.: US 2011/0260640 A1
(43) Pub. Date: Oct. 27, 2011

(54) POWER SUPPLY CIRCUIT FOR LIGHT SOURCES, SUCH AS LIGHTING LED SYSTEMS

(75) Inventors: Federico Carraro, Cornuda (Treviso) (IT); Paolo De Anna, Vallaà di Riese Pio X (Treviso) (IT); Michele Menegazzi, Paese (Treviso) (IT)

(73) Assignee: OSRAM GESELLSCHAFT MIT BESCHRAENKTER HAFTUNG, Muenchen (DE)

(21) Appl. No.: 13/091,261

(22) Filed: Apr. 21, 2011

(30) Foreign Application Priority Data
Apr. 21, 2010 (IT) TO2010A000335

(51) Int. Cl. H05B 37/02

(52) U.S. Cl. 315/291

(57) ABSTRACT

In various embodiments, a power supply circuit for light sources is provided. The power supply circuit may include a ground line and a current feed line towards said light source, wherein said circuit includes an output inductor interposed in said current feed line, the circuit including an electronic switch interposed in said feed line switchable between an on condition, wherein said electronic switch is configured to ensure continuity of said feed line, and an off condition, wherein said electronic switch is configured to interrupt said current feed line, the circuit further including a rectifier set interposed between said output inductor and said electronic switch to rectify the voltage across said output inductor, the voltage produced by said rectifier set constituting a drive voltage to maintain said electronic switch in said on condition.

### CROSS-REFERENCE TO RELATED APPLICATION

This application claims priority to Italian Patent Application Serial No. TO2010A000335, which was filed Apr. 21, 2010, and is incorporated herein by reference in its entirety.

### TECHNICAL FIELD

The present disclosure relates to circuits for supplying light sources.

This disclosure was devised with specific attention paid to its possible application to the supply of lighting LED systems.

### BACKGROUND

The block diagram in FIG. 1 shows in general terms a solution used to supply power to a light source S, for example a lighting LED system.

Specifically, FIG. 1 refers to a lighting LED system including an “intelligent” module 10 having, beside light source S (including one or more LEDs), a control logic circuit 12 mounted on board module 10.

The related power supply circuit, generally denoted by 20, is therefore designed in such a way as to deliver towards LED module 10 both a supply current Iout for the LEDs of light source S and a supply voltage +AUX for logic circuit 12.

In the embodiment shown in FIG. 1, this is implemented by providing, in addition to a ground terminal 22, a current (Iout) feed terminal/line 24, and a voltage (+AUX) feed terminal/line. The power supply circuit 20 may be a Switch Mode Converter. In various embodiments, LED module 10 and power supply circuit 20 can communicate by means of an analogue or digital bus.

In “current-driven” modules 10 as shown in FIG. 1, the output voltage of power supply circuit 20 can reach values in the range from 0 V to the maximum allowed voltage, depending on the operating conditions of the load. Therefore, it can be useful (or even mandatory, in order to comply with safety standards and fail safe requirements) that the power output of the power supply circuit (i.e. the terminal/line 24, in the example shown in FIG. 1) can be “disconnected” from module 10, i.e. can be switched off by means of an active switch (for example an electronic solid-state switch, such as a power MOSFET).

In order to meet this need it is possible to interpose said switch in ground line 22.

This solution has a drawback in that, when the ground line 22 is interrupted, an undesired inverse polarisation of the logic circuit 12 may take place. Moreover, with such a design the power supply to the LEDs of source S cannot be interrupted while delivering energy to logic module 12 via line 22.

As an alternative, said switch could be moved to line 24, interposing it in that very line, so that the switch can be switched between an on condition (conducting), wherein it ensures the continuity of the power feed line, and an off condition (non conducting), wherein the switch interrupts such power feed line.

This requires the presence of an auxiliary voltage on the “high side” of power supply circuit 20, in order to supply the switch which, as stated above, may be comprised of a power MOSFET.

In principle, this auxiliary voltage can be generated via an additional auxiliary winding, on the power transformer provided in a power supply circuit 20 of a switch-mode type. However, this solution is not practicable with all topologies of circuit 20 (for example, it would not be applicable to a buck converter).

Another theoretically possible solution would be to use PMOS switches. However, especially at high operating voltage (80 V or higher), such components turn out to be very expensive as compared to NMOS components. As a consequence, this solution is not suitable in all those applications where costs play an important role.

### SUMMARY

In various embodiments, a power supply circuit for light sources is provided. The power supply circuit may include a ground line and a current feed line towards said light source, wherein said circuit includes an output inductor interposed in said current feed line, the circuit including an electronic switch interposed in said feed line switchable between an on condition, wherein said electronic switch is configured to ensure continuity of said feed line, and an off condition, wherein said electronic switch is configured to interrupt said current feed line, the circuit further including a rectifier set interposed between said output inductor and said electronic switch to rectify the voltage across said output inductor, the voltage produced by said rectifier set constituting a drive voltage to maintain said electronic switch in said on condition.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows has already been described in the foregoing; and

FIG. 2 is a block diagram of an embodiment.

### DETAILED DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Various embodiments propose solutions that can overcome the previously described drawbacks.

The claims are an integral part of the technical teaching of the invention provided herein.

In various embodiments, the problem of creating the high-side voltage in order to drive the electronic switch is solved according to criteria that are applicable in all “forward-like” topologies, both insulated and not insulated, such as buck (step-down) converters, half-bridge, Single Switch Forward Converters and all possible derivatives from such basic topologies.

In various embodiments, this result is achieved by means of a simple circuit, using few low-cost components, and without the need of providing, for example, an additional winding in a transformer in the converter.

The headings provided herein are for convenience only and do not interpret the scope or meaning of the embodiments.

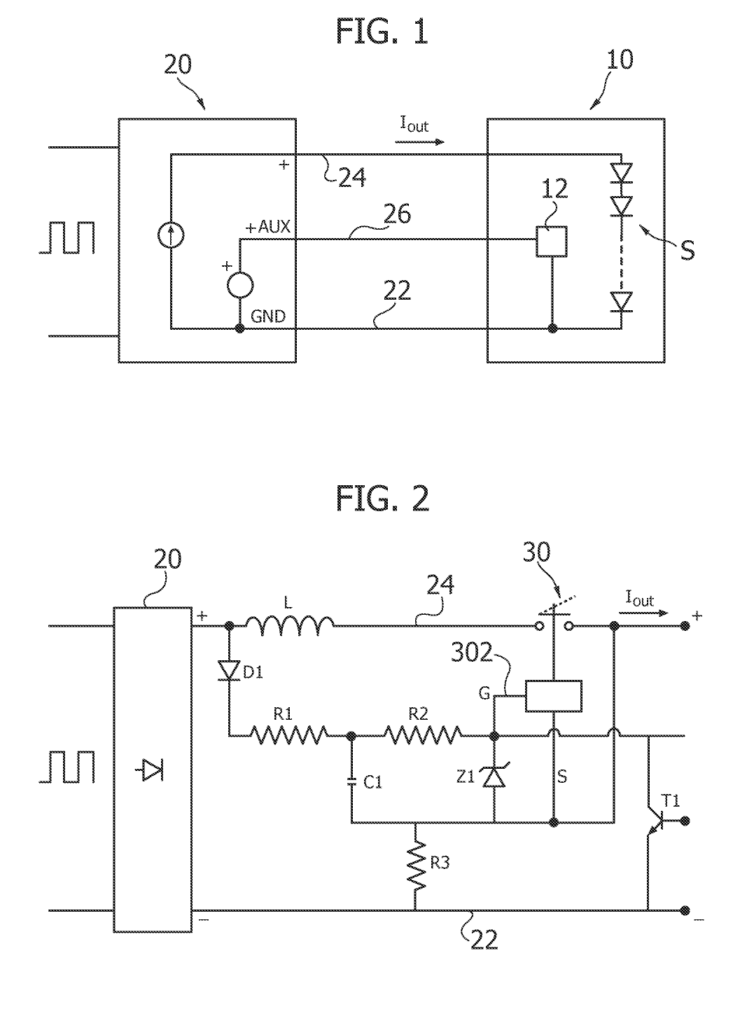

In FIG. 2 parts, elements or components identical or equivalent to parts, elements or components already described with reference to FIG. 1 are denoted by the same reference numbers; therefore, the description thereof will not be repeated in the following.

FIG. 2 refers to embodiments wherein, in a circuit as described with reference to FIG. 1, which is adapted to feed a supply current Iout to a LED module 10 (or to a similar light source), in power feed line 24 an electronic switch 30 is interposed which is comprised for example of an NMOS power transistor.

Terminal/line 26 shown in FIG. 1 is not explicitly shown in FIG. 2, because it is unimportant for the understanding and the implementation of the embodiments. In various embodiments, however, terminal/line 26 may have to be present.

Various embodiments are based on the provision (as is the case in all forward derived topologies previously referred to) of an output inductor L, which can be assumed to be interposed in line 24, serially connected to switch 30. Reference 302 denotes explicitly the related control terminal of electronic switch 30 (e.g. gate G of an NMOS transistor).

The exemplary embodiment referred to in FIG. 2 has the voltage across output inductor L rectified by a circuit including, in a set, a diode D1, connected via its anode to terminal/line 24 (i.e. to the positive output of power supply circuit 20), a resistor R1 and a capacitor C1.

In this way, across C1 a “high” supply voltage is produced. This voltage is then applied between gate G and source S of NMOS transistor 30 through a coupling resistor R2 and a zener diode Z1, which limits the maximum applied voltage between G and S.

In various embodiments, moreover, a further electronic switch T1 may be provided (e.g. a bipolar or MOS, preferably NMOS transistor) which operates between gate G (i.e. the control terminal of switch 30) and ground line 20. The arrangement is therefore such that, when switch T1 is closed (conducting), the gate or control terminal of switch 30 is connected to ground terminal 20.

The control terminal of further switch T1 (the base in a bipolar transistor or the gate in a MOS transistor) actually represents the terminal across which (via an external command, generated according to known criteria which are not particularly relevant to the description) it is possible to switch on (turn to conducting) or off (turn to non conducting) power switch 30.

The embodiments referred to in FIG. 2 are based on the fact that rectifier set D1, R1, C1 generates a rectified version of the voltage across inductor L.

Such rectified voltage charges capacitor C1, so as to be ballasted, and is used to drive the control electrode (gate) of switch 30.

During normal operation, capacitor C1 is charged with the current flowing through the LEDs of module 10 (light source S) and the voltage across it and across zener diode Z1 keeps the gate/source voltage of electronic switch 30 at a “high” level, and therefore the electronic switch 30 is kept in a closed state.

If line 24 must be “disconnected” (for example if load S is removed), transistor T1 is closed, so that it grounds gate G of switch 30, and line 24 is interrupted.

In these conditions, capacitor C1 can keep on being charged (even when load S is absent) via a further resistor R3 connected between the terminal of capacitor C1 opposite resistor R1 and ground line 22.

In order to “reconnect” line 24 (for example if load S is coupled again), transistor T1 is opened and the voltage across capacitor C1 is once again applied between gate and source (G-S) of switch 30 via zener Z1, in this way making the line of switch 30 conducting and coupling line 24 to the load.

Various embodiments allow therefore to use a high-side electronic switch to connect and disconnect load S, without affecting the physical connection of ground line 22, which allows to preserve the desired power supply state of logic circuit 12 in FIG. 1.

Various embodiments, as shown in FIG. 2, are based on a simple circuit, which does not require an auxiliary winding of a transformer (if present) in circuit 20.

Moreover, the envisaged solution is generally very economical, particularly in comparison with the possible use of PMOS components.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A power supply circuit for light sources, said power supply circuit comprising:
a ground line and a current feed line towards said light source,
wherein said circuit includes an output inductor interposed in said current feed line, the circuit comprising an electronic switch interposed in said feed line switchable between an on condition, wherein said electronic switch is configured to ensure continuity of said feed line, and an off condition, wherein said electronic switch is configured to interrupt said current feed line, the circuit further comprising a rectifier set interposed between said output inductor and said electronic switch to rectify the voltage across said output inductor, the voltage produced by said rectifier set constituting a drive voltage to maintain said electronic switch in said on condition.

2. The circuit of claim 1,
wherein said rectifier set comprises a capacitor whose charge voltage drives the control electrode of said electronic switch.

3. The circuit of claim 2,
wherein a zener diode is coupled to said capacitor to limit the voltage applied from said capacitor to the control electrode of said electronic switch.

4. The circuit of claim 2, further comprising:
a coupling resistor to apply the voltage of said capacitor to the control electrode of said electronic switch.

5. The circuit of claim 2, further comprising:
coupled to said capacitor, a further resistor interposed between said capacitor and said ground line, said further resistor permitting loading of said capacitor when said current feed line is interrupted.

6. The circuit of claim 1,
wherein said electronic switch is a NMOS transistor.

7. The circuit of claim 1, further comprising:
a further electronic switch to selectively connect to said ground line said control electrode of said electronic switch.

8. The circuit of claim 7,
wherein said further electronic switch is selected out of a bipolar transistor and a MOS transistor.
